(19) United States
(12) Patent Application Publication
(10) Pub. No.: US 2005/0072475 A1
(43) Pub. Date: Apr. 7, 2005

(54) Precision valve for a garment vacuum bag

(76) Inventor: Kwang Soo Seo, Icheon City (KR)

Correspondence Address: Eugene Oak, Ph.D., J.D., 610 S. Van Ness Ave., Los Angeles, CA, 90005, US

(21) Appl. No.: 10/677,996

(22) Filed: Oct. 3, 2003

(51) Int. Cl. F16K 15/16

(52) U.S. Cl. 137/512.15

(57) ABSTRACT

A one-way valve for evacuating air from a collapsible, flexible, airtight bag using a vacuum source. After the air is removed from the airtight bag, the one-way valve prevents air from re-entering the bag. A flat annular silicon valve and a valve body without center hole is provided for precise closing of the valve.

### FIELD OF THE INVENTION

The present invention relates to a precision valve for a garment vacuum bag, and in particular to valve and valve body for one-way valves used in such garment bag.

### BACKGROUND OF THE INVENTION

Vacuum applicable garment bag typically include a flexible, airtight bag, an opening through which to place an article in the bag, and a valve through which to evacuate excess air. A user places an article into the bag through the opening, seals the opening, and then evacuates the air in the bag through the valve. The valve for such purpose should be endurable for repeated evacuation and deforming. And at the same time it should be simple to reduce production cost. FIG. 1 and FIG. 2, respectively, is a perspective view and a cross sectional view of the air valve for collapsible vinyl bag of the prior art of U.S. Pat. No. 6,408,872. As shown, valve assembly (10) is comprised of a base (12), holding the valve tightly on the surface of a bag, and a valve element (20). The valve element (20) provides the one-way feature in the valve assembly (10). The valve element (20) is comprised of an outer annular portion (26), an inner diaphragm (22) supported by the outer annular portion (26), and a stem (24). The outer annular portion (26) functions as a face against which a vacuum source may be sealed as the nozzle is pressed against base (12). When the nozzle is in place and a vacuum pressure draws air through the nozzle, the inner diaphragm (22) flexes open and air passes through a plurality of holes (15) in the base (10). When the nozzle is removed, diaphragm (22) returns to its original shape and seals against base (10), thus preventing air from passing back through holes (15). The diaphragm (22) should be resilient enough to return to its original dimension as soon as the vacuum is removed. However, the material used in '872 for the diaphragm (22) is flexible PVC (poly vinyl chloride), which has poor resiliency. Therefore, air comes into the collapsible vinyl bag through the leaks between the diaphragm (22) and the base 16 of '872 just after the vacuum is removed from the valve. Sweeney in U.S. Pat. No. 5,480,030 illustrates diaphragm of similar design made of silicon.

Similarity of the valve of the two prior arts are 1) they have an inner diaphragm supported by an outer annular portion and 2) they have a stem to hold the diaphragm tightly adhere to the bottom of the valve. Whatever the material of the valve, the stem equipped valve is hard to manufacture and engage to the bottom of the valve. It is the purpose of this invention to provide a valve, which is simpler to manufacture, and more simple to engage without loosing the tightness of sealing.

### DESCRIPTION OF THE PRIOR ARTS

U.S. Pat. No. 5,121,590 to Scanlan illustrates a valve for evacuating and sealing containers for perishable food or other substances. The valve 16 is situated on the outer surface 22 of lid 14 over the air passage 21. The lower portion 23, including the hollow interior region 24, has a greater breadth or diameter than the air passage 21 of lid 14. Consequently/ after evacuation of the container 12, the external atmosphere exerts pressure against a greater area of valve 16 than would be the case if the underside of the valve were exposed to vacuum only at air passage 21. The stem 31 of this embodiment is integral with other portions of the valve 16 and thus is formed of the same resilient elastic material. Forcing of the enlargement 33 through passage 21 is facilitated if the enlargement has the shape of an inverted truncated cone and has a lower end that is of smaller diameter than the passage and an upper end that is of slightly greater diameter than the passage.

U.S. Pat. No. 5,480,030 to Sweeney et al., discloses a one-way air valve assembly having a flexible diaphragm that seals against a valve seat. The valve 18 is made of an elastic material, such as silicone rubber, and includes a diaphragm 26, diaphragm slots 27, a stem 28, and a retainer 30. When assembling valve assembly 6, stem 28 is inserted into valve assembly 6 through holes 31a and 31b. Retainer 30, being elastic, compresses as stem 28 is pulled through the hole 31a. Once through hole 31a, retainer 30 regains its shape, and thereby secures valve 18 in valve assembly 6.

U.S. Pat. No. 6,408,872 to Skeens, et al. illustrates another one-way valve allowing air to be drawn from a collapsible, flexible, airtight bag using a vacuum source. The valve assembly 6 is comprised of a base 16, a retaining ring 18, and a valve element 20. Valve element 20 provides the one-way feature in valve assembly 6. The valve element 20 is made of conventional clear polyvinylchloride (PVC). Valve element 20 has an outer annular portion 22 and an inner diaphragm 24. The inner diaphragm has a stem, which is fixed to the base 16 by penetrating the central valve element support 29.

Most of the prior arts for one-way vacuum for collapsible packaging utilize a flexible stem, which penetrates the lower bottom of the valve and locates inside of the package to be evacuated. None of the prior art utilizes a simple valve having no stems at all.

### SUMMARY OF THE INVENTION

A one-way valve for evacuating air from a collapsible, flexible, airtight bag using a vacuum source. After the air is removed from the airtight bag, the one-way valve prevents air from re-entering the bag. A flat annular silicon valve and a valve body without center hole is provided for precise closing and increase of the endurance of the valve. Cap of the valve is made of flexible poly-vinylchloride to increase the sealing ability of the cap.

### BRIEF DESCRIPTION OF THE DRAWINGS

FIG. 1 is a perspective view of the air valve for a vacuum vinyl bag of the prior art.

FIG. 2 is a cross sectional view of the air valve for a vacuum vinyl bag of the prior art.

FIG. 3 is a perspective view of the air valve for a vacuum vinyl bag of the present invention.

FIG. 4 is a bottom view of the first valve body of the air valve for a vacuum vinyl bag of the present invention.

FIG. 5a is a cross sectional view of the air valve for a vacuum vinyl bag of the present invention along the line A-A in FIG. 4.

FIG. 5b. is a cross sectional view of the air valve for a vacuum vinyl bag of the present invention along the line B-B in FIG. 4.

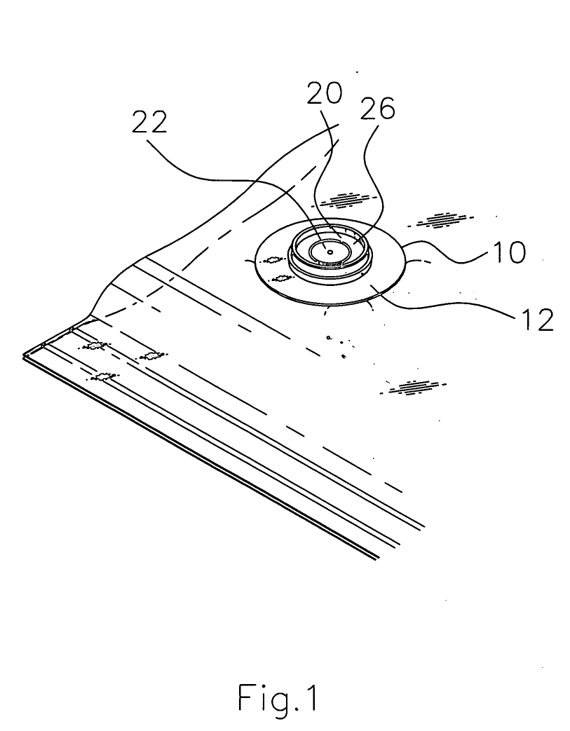

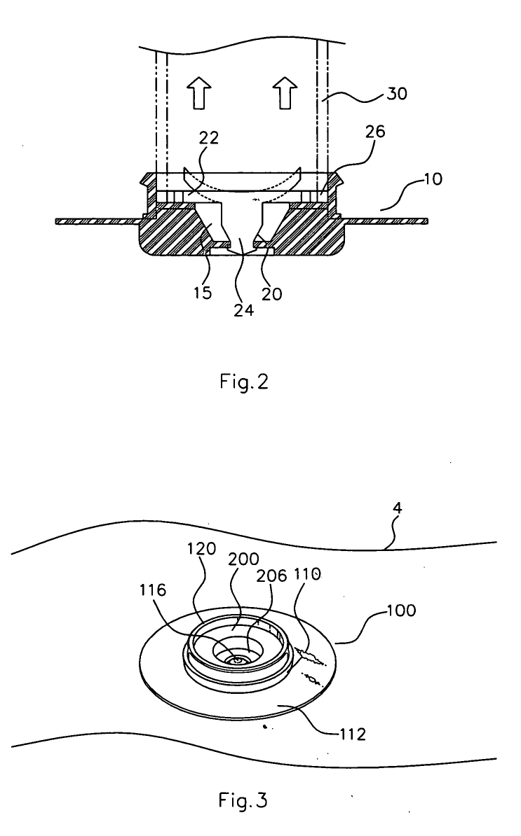

### DETAILED DESCRIPTION OF THE PREFERRED EMBODIMENT

FIG. 3 is a perspective view of the air valve for a vacuum vinyl bag of the present invention. The air valve body (100) is comprised of a first valve body (110) which has an air path (208) and a second valve body (120). A flexible valve (200) made of silicon is engaged between the first valve body (110) and the second valve body (120). A ring (112), locating the outer surface of the collapsible vinyl bag (4), supports the valve body (100), which locates inside surface of the vinyl bag (4).

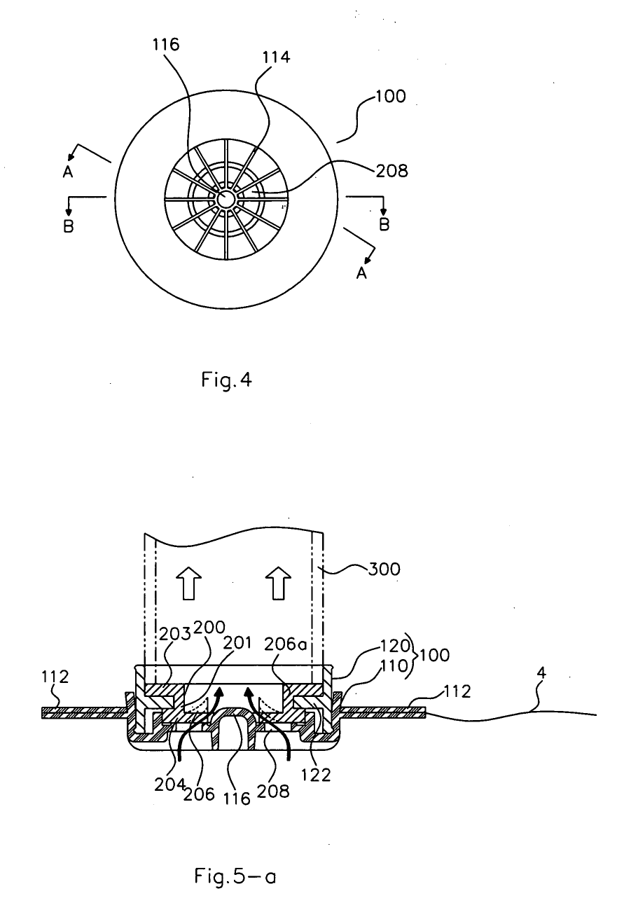

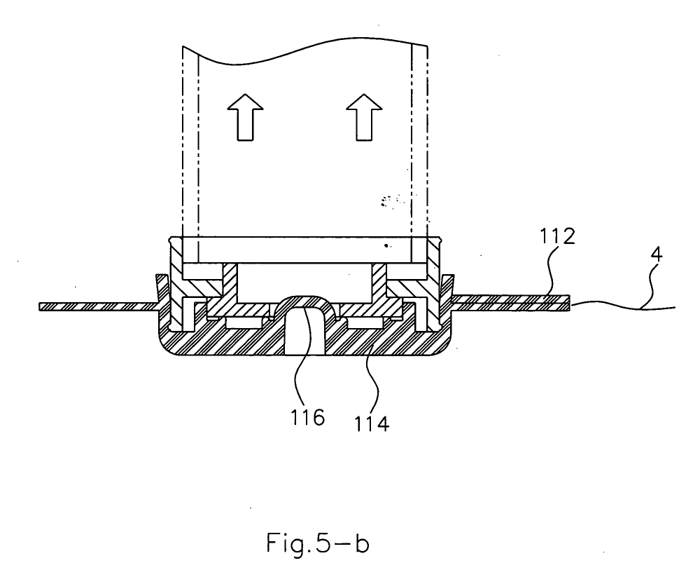

FIG. 4 is a bottom view of the first valve body (110) of the air valve for a vacuum vinyl bag of the present invention and FIG. 5a is a cross sectional view of the air valve for a vacuum vinyl bag of the present invention along the line A-A in FIG. 4.

A hemi-sphere knob (116) is developed at the center of the first valve body (110). The hemi-sphere knob (116) is connected to the first valve body (110) by pluralities of the vanes (114) developed in radial direction from the knob (116) to the outer radius of the lower surface of the first valve body (110). Pluralities of air path holes (208) are developed between the vanes (114).

A flexible valve (200) made of silicon has a hole (207) at the center. The valve (200) has a circular wall (201) developed on the upper surface of the base annular plate (204) and an upper annular plate (203) developed outward around the circular wall (201). Part of the base annular plate (204) inside of the circular wall (201) is named as (206). The valve (200) is placed on the first valve body (110) with the hemi-sphere knob (116) engaged to the center hole (207). Then the inside annular plate (206) covers the air path holes (208). Insert the second valve body (120) to the first valve body (110) placing the valve (200) underneath. Finally, engage the ring (112) to the valve body (100).

When applying vacuum, insert the vacuum hose (300) into the second valve body (120), press the upper annular plate (203) and turn on the vacuum pump (not shown). The air inside of the collapsible vinyl bag (4) comes out through the air path holes (208). Then the air pushes the inside base annular plate (206) to the position (206a) and comes out to the vacuum pump.

When the vacuum is removed, the inside base annular plate (206) returns from the position of (206a) to (206) and blocks the air path holes (208). The structure of the valve (200) of this invention make the valve (200) returns quickly to the original position without deforming the valve (200). And more over, the structure of the valve (200) is much more simpler than the prior art and easy to engage to the valve body (100). Finally, cover the second valve body (120) with a cap made of soft poly vinylchloride (not shown in this invention).

1. A valve body for a collapsible vinyl bag comprised of; 1) a first valve body, which has a hemi-sphere knob, which is developed at the center and is connected to the first valve body by pluralities of the vanes developed in radial direction from the knob to the outer radius of the lower surface of the first valve body and has pluralities of air path holes developed between the vanes, 2) a second valve body, 3) a flexible silicon valve, which has a circular wall developed on the upper surface of the base annular plate and an upper annular plate developed outward around the circular wall, and which is engaged between the first valve body and the second valve body locating the hole at the center of the base plate onto the hemi-sphere knob of the first valve body, 4) a ring, which is located at the outer surface of a collapsible vinyl bag, supporting the valve body which locates inside surface of the vinyl bag, and 4) a cap made of soft poly vinylchloride.
